(19) United States
(12) Patent Application Publication
(10) Pub. No.: US 2009/0104400 A1
(43) Pub. Date: Apr. 23, 2009

(54) Clean-Up Pal

(76) Inventor: Audrey Denise Chin, Ponte Vedra, FL (US)

Correspondence Address: Audrey Chin Zeltray, 202 Pheasant Run, Ponte Vedra, FL, 32082, US

(21) Appl. No.: 11/975,641

(22) Filed: Oct. 22, 2007

(51) Int. Cl. B32B 3/10

(52) U.S. Cl. 428/131

(57) ABSTRACT

The invention is a tablecloth that doubles into a garbage bag. What is new is the concept of cinching the skirt while eating, cinching the top while away from your food thereby protecting it and then, after removing the leftovers and/or non-disposables, picking it all up and throwing it away.

### CROSS-REFERENCE TO RELATED APPLICATIONS

A tablecloth and a garbage bag.

### STATEMENT REGARDING FEDERALLY SPONSORED RESEARCH OR DEVELOPMENT

Not applicable

### REFERENCE TO SEQUENCE LISTING, A TABLE OR A COMPUTER PROGRAM LISTING COMPACT DISC APPENDIX

Not applicable

### BACKGROUND OF INVENTION

Currently, people are having to use a tablecloth then make several trips to the garbage. This not only sometimes cause additional messes, (spills on the floor and/or other surface areas), but it also takes some time to complete.

Another problem is the skirt of the tablecloth becoming unruly during outdoor or even indoor events.

Yet another problem is when people have eaten and they are away from the leftover food. Flies, ants, sand, wind, rain, sun, animals or even people can get into your food because it is unprotected.

### BRIEF SUMMARY OF THE INVENTION

The Clean-Up Pal will allow any mess to be cleaned up with a cinch. The draw string, which goes around the edge of the tablecloth, can be easily pulled then simply picked up and thrown away. Also, the skirt can be cinched at the bottom so it stays in place.

Lastly, by cinching it on top, your food is protected from all elements.

The object of the invention is just to make people's lives a whole lot easier when trying to have fun either indoors or outside.

### BRIEF DESCRIPTION OF THE SEVERAL VIEWS OF THE DRAWING

FIG. 1A. Cinched at the bottom.

FIG. 2A. Cinched at the top.

FIG. 3A. In the garbage can.

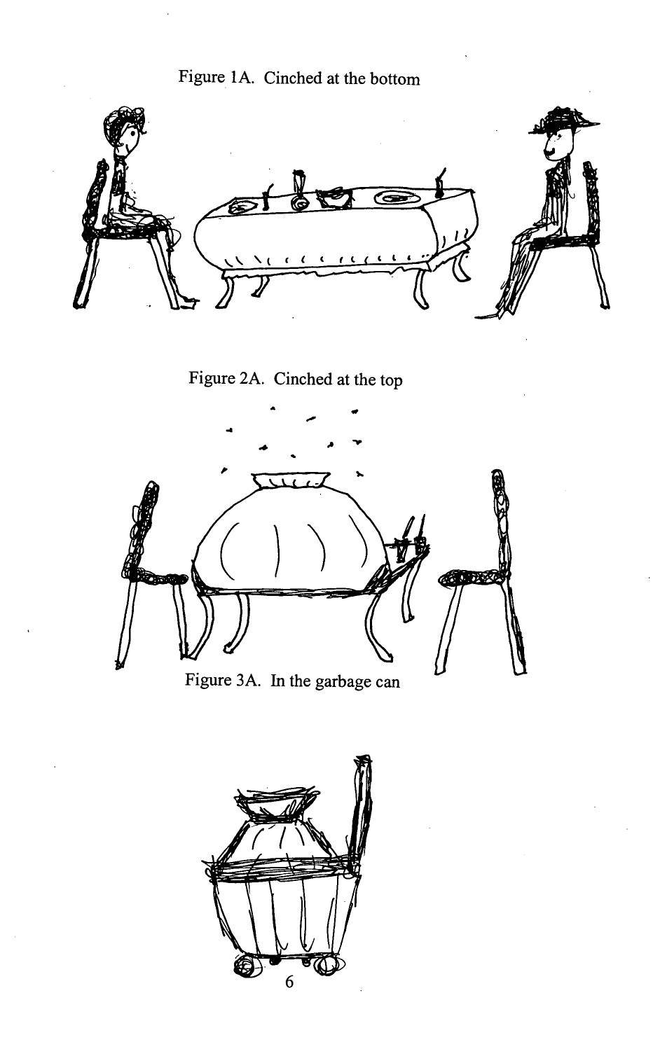

### SPECIFICATIONS OF PRODUCT

It will be oval in shape with the measurements being around 5′ by 7′ to accommodate the average size table. There will be different sizes in time.

### DETAILED DESCRIPTION OF THE INVENTION

The old way is to buy a tablecloth and an extra box of garbage bags then, after the event, having to contend with taking all the garbage from the table to the garbage bag. The improvements are: saving time and money. The composition of matter will be 100% recycled materials. It will be made out of paper that is strong enough to hold light weight garbage yet flexible enough to behave like a tablecloth. Currently, garbage bags and a lot of tablecloths are plastic. The Clean-Up Pal will not only be user friendly, but environmentally friendly as well.

What I claim as my invention:

1. A tablecloth that doubles into a garbage bag.
